(19) United States
(12) Patent Application Publication
(10) Pub. No.: US 2015/0276955 A1
(43) Pub. Date: Oct. 1, 2015

(54) Method and System for Extending Spatial Wavenumber Spectrum Of Seismic Wavefields On Land Or Water Bottom Using Rotational Motion

(71) Applicant: Robert H. Brune, Evergreen, CO (US)

(72) Inventor: Robert H. Brune, Evergreen, CO (US)

(21) Appl. No.: 14/534,691

(22) Filed: Nov. 6, 2014

Related U.S. Application Data
(60) Provisional application No. 61/900,953, filed on Nov. 6, 2013.

(51) Int. Cl. G01V 1/30; G01V 1/32; G01V 1/00

(52) U.S. Cl. CPC G01V 1/303; G01V 1/003; G01V 1/32; G01V 2210/30

(57) ABSTRACT

The present invention provides extensions to the sampled spatial wavenumber spectrum of a seismic wavefield on the free surface of the earth or at the bottom of a body of water to wavenumbers higher than the Nyquist limit for the physical layout spacing of the seismic sensor units. The seismic sensor units are comprised of linear sensing elements for at least linear vertical particle motion; and rotational sensing elements for rotational motion around at least one, or more, horizontal axes. Stress and wavefield conditions known on the land surface of the earth or on a water bottom allow the rotational sensing element to yield the transverse horizontal gradient of the vertical particle motion wavefield. This horizontal gradient and the linear vertical particle motion data are utilized in techniques of sample reconstruction to yield an improved horizontal spatial sampling of the linear vertical particle motion wavefield. These reconstructed seismic wavefield samples represent spatial wavenumbers beyond the basic spatial Nyquist limit when using only linear sensors for the seismic sensor unit spacing employed. The method has a wide range of application in seismic surveys for oil and gas exploration and production, and for other purposes.

### CROSS REFERENCE TO RELATED APPLICATIONS

This application claims the benefit under 35 USC §119 (e) of U.S. Provisional Patent Application No. 61/900,953 filed on Nov. 6, 2013, the disclosure of which is incorporated herein by reference.

### FIELD

The present invention pertains to the art of seismic surveying and seismic data processing for the exploration and production of petroleum reservoirs and for other purposes, and more specifically to the joint use of linear and rotational sensors on the free surface of the earth or the bottom of a body of water to enhance the spatial wavenumber sampling of seismic wavefields, and to enhance the processing of data to generate images of the subsurface.

### BACKGROUND

There is a long term trend in seismic reflection surveying for oil and gas exploration and production to utilize sensing elements, commonly known as geophones, at decreasing spatial sample intervals. There is a continuing need for economical ability to measure seismic wavefields at finer spatial sampling.

There is a well-established technology for measurement of the linear particle motion of seismic wavefields in the earth. Many commercial sensors exist to measure particle velocity or particle acceleration along one, or up to three, linear axes, utilizing various physical concepts to accomplish the measurements. It is most common to utilize measurements of the vertical particle motion.

There is an evolving commercial technology for measurement of the rotational particle motion of seismic wavefields in the earth. This includes sensors such as those being developed and commercially offered by, for example, Applied Technology Associates (e.g., model ARS-14), eentec (e.g., model R-1 and R-2), and MetTech (e.g., model Metr-3). Seismic rotational motion is understood to be the vector curl of the infinitesimal displacement field. The existing rotational sensors are understood to measure the vector components of this vector curl, or its time derivatives.

The significant effect of the free surface of the earth, or the bottom of a body of water, on stress fields, strain fields, and seismic wave fields is widely understood. See, for example, Aki, K., and Richards, P., 2002, Quantitative Seismology, University Science Books, p. 128 ff., pp. 184-185. For example, the stress components, commonly referred to as σ_{xz} and σ_{yz}, involving the nominal vertical direction, normal to the free surface or water bottom, have zero value at those surfaces.

In the field of sampled data analysis, there is a well-established technology for effectively enhanced sampling rate by utilizing the sampling of the values of a waveform and sampling the gradient of the same waveform. This technology is commonly understood for time series data, and is also directly applicable to spatial sampling. For a description of this technology see, for example, Bracewell, R., 2000, The Fourier Transform and its Applications, McGraw-Hill, pp. 230-232 and see also Butzer, P. L., Schmeisser, G., and R. L. Stens, 2001: “An introduction to sampling analysis”, in “Nonuniform sampling: theory and practice”, F. Marvasti, ed., Kluwer Academic/Plenum Publishers, New York, equation (92) on p. 61.

### SUMMARY

In one embodiment there is provided a method for reconstructing seismic wavefield samples representative of wavenumbers beyond the basic Nyquist spatial sampling wavenumber comprising: deploying a plurality of seismic sensor units in a sensor array incorporating both linear and rotational sensing elements designed for seismic sensitivities and frequencies and reconstructing seismic wavefield samples representative of wavenumbers beyond the basic Nyquist spatial sampling wavenumber limit that would be imposed by the seismic sensor unit spacing utilized if only vertical linear components of motion were recorded

In another embodiment there is provided a method for enhancing attenuation of ground roll, Rayleigh waves, Scholte waves, or other source generated seismic noise detected on the surface of the land or on a water bottom, comprised of: performing f-k filtering or equivalents on a data set in temporal and spatial Fourier transform domain, wherein spatial wavenumbers beyond the basic Nyquist spatial sampling wavenumber limit that would be imposed by the seismic sensor unit spacing are created by: recording the wavefield and its horizontal spatial gradient at sensor locations; calculating the spatial Fourier components of the wavefield and its horizontal spatial gradient; equating the wavefield and its horizontal spatial gradient, each in one of a pair of equations, each in terms of unknown aliased and unaliased portions of the wavefield; and calculating the spatially aliased portion and the spatially unaliased portions of the spatial Fourier component representation of the wavefield.

In another embodiment there is provided a system for reconstructing seismic wavefield samples representative of wavenumbers beyond the basic Nyquist spatial sampling wavenumber comprising: a plurality of seismic sensor units incorporating both linear and rotational sensing elements that are designed for seismic sensitivities and frequencies, deployed in a partly or wholly uniform and/or non-uniformly spaced array on land or on the bottom of a body of water, and computers to reconstruct seismic wavefield samples representative of wavenumbers beyond the basic Nyquist spatial sampling wavenumber limit that would be imposed by the seismic sensor unit spacing utilized if only vertical linear components of motion were recorded.

Further embodiments are disclosed herein or will become apparent to those skilled in the art after having read and understood the specification and drawings hereof. This summary may be more fully appreciated with respect to the following description and accompanying figures and attachments.

### BRIEF DESCRIPTION OF THE DRAWINGS

Different aspects of the various embodiments of the invention will become apparent from the following specification, drawings and claims in which:

FIG. 1 is a diagrammatic view of the linear motion and rotational motion of a seismic sensor unit on the free surface of the earth or on the bottom of a body of water;

FIG. 2 is a diagrammatic representation of the signal reconstruction aspect of the present invention using linear vertical motion measurements and horizontal spatial gradients of the linear vertical motion as measured by rotational sensors;

FIG. 3 depicts prior art for signal reconstruction;

FIG. 4 depicts prior art for signal reconstruction;

FIG. 5A depicts a typical set of parallel receiver lines with a typical crossline spacing;

FIG. 5B depicts a set of receiver lines with twice the typical crossline spacing;

FIG. 5C depicts an exemplary 3-D seismic survey with typical inline and crossline spacings and

FIG. 5D depicts a 3-D seismic survey with irregular inline and crossline spacings.

The drawings are not necessarily to scale. Like numbers refer to like parts or steps throughout the drawings.

### DETAILED DESCRIPTION OF SOME EMBODIMENTS

Before proceeding with the detailed description, it is to be appreciated that the present teaching is by way of example only, not by limitation.

In the following description, specific details are provided to impart a thorough understanding of the various embodiments of the invention. Upon having read and understood the specification, claims and drawings hereof, however, those skilled in the art will understand that some embodiments of the invention may be practiced without adhering to some of the specific details set forth herein. Moreover, to avoid obscuring the invention, some well-known methods, processes and devices and systems finding application in the various embodiments described herein are not disclosed in detail. Persons having ordinary skill in the art will recognize that there may be many implementation-specific details that are not described here, but that would be considered part of a routine undertaking to implement the inventive concepts of the present invention.

Several embodiments of the present invention are discussed below. The appended drawings illustrate only typical embodiments of the present invention and therefore are not to be considered limiting of its scope and breadth. In the drawings, some, but not all, possible embodiments are illustrated, and further may not be shown to scale.

An object of the present invention is to improve horizontal spatial sampling of a seismic wavefield on the free surface of the earth or on the bottom of a body of water without the need to occupy more locations for seismic sensor units.

Another object of the present invention is to obtain equivalent horizontal spatial sampling of a seismic wavefield on the free surface of the earth or on the bottom of a body of water with the allowance to occupy fewer locations for seismic sensor units. A method and system are provided to use a novel combination of the more complete description of seismic wavefield motion offered by seismic sensor units that incorporate rotational motion sensors and linear motion sensors.

A further object of the invention is to increase the effective sampled wavenumbers in one or more horizontal directions for a particular number of locations occupied by seismic sensor units, compared to prior art commercial practice.

The invention includes, in its many aspects and embodiments, a method and system to enhance the spatial sampling of seismic wavefields recorded on the free surface of the earth or on the bottom of a body of water. This may allow for fewer seismic sensor units at a greater spacing and/or allow for sampling of larger horizontal wavenumbers compared to sampling with only linear vertical motion sensors. This is accomplished using linear vertical particle motion and rotational motion around horizontal axes. More particularly, the method comprises: recording the linear vertical particle motion; recording the rotational motion around one or more horizontal axes; using this rotational motion as representative of the horizontal spatial gradient of the linear vertical motion; and using this horizontal spatial gradient of the linear vertical particle motion, along with the linear vertical particle motion in a sample reconstruction algorithm.

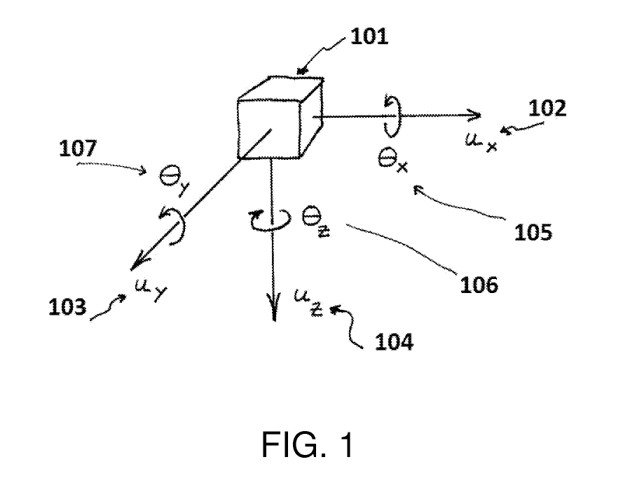

FIG. 1 depicts the six degree-of-freedom motion of a seismic sensor unit 101. A Cartesian coordinate system is used, but those skilled in the art will recognize that various alternate equivalent coordinate systems and representations of particle motion may be used, including the ability to handle the case of a sloping free surface. The motion is comprised of three linear motions, 102-104, and three rotational motions, 105-107. A right-hand rule for axes and rotation sign conventions is used throughout for the present invention.

It will be understood by persons having ordinary skill in the art that the orientation of axes for linear seismic measurements may be numerically rotated to any arbitrarily desired axis orientation. See, for example, U.S. Pat. No. 6,076,045 to Naville entitled “Method For Processing Oriented Multi-Component Seismic Well Data”. In the present invention it is understood that rotational measurements from seismic sensor units are components of the vector curl of infinitesimal displacement, or its time derivatives. Therefore, rotational measurements are components of a pseudovector, and may be rotated numerically to components representative of any other arbitrarily desired axis orientation.

U.S. Pat. No. 7,286,442 to Ray entitled “Method And Apparatus For Seismic Data Acquisition” discloses at col. 24, l. 18, and l. 21-23: “ . . . seismic unit includes . . . Generally, such a system measures movement in each of the x, y, and z dimensions as well as angular movement around each x, y, and z axis.” However, persons having ordinary skill in the art will further note that this disclosure pertains to (col. 24, l. 18-21) “ . . . an inertial navigation system to measure the unit's x, y, and z position information as the unit is passing through the water column and settles on the ocean floor”. Those skilled in the art will recognize that this prior art pertains to navigational positioning which requires rotational accuracy and sensitivity of perhaps the order of magnitude of 0.01 radian, and with attention to low frequencies and long term drift performance. This prior art has utility only while the unit is in motion in the water column, not after it is deployed in a fixed location for seismic data to be recorded. In a significant departure from the prior art, the seismic sensor units 101 in the present invention include measurements of rotation, typically rotational rate, with accuracy and sensitivity on the order of micro-radians/second, or better, for a frequency bandwidth extending up to the order of magnitude of 100 Hz or more.

There is extensive prior art addressing various techniques to interpolate seismic data, including, for example, U.S. Pat. No. 6,021,379 to Duren, et. al., entitled “Method For Reconstructing Seismic Wavefields”. This patent includes an extensive analytical discussion in an Appendix (cols. 14-48). In a significant departure from this prior art, the present invention utilizes measurements of spatial gradients from rotational sensors to extend data reconstruction beyond the horizontal spatial basic Nyquist wavenumber limits imposed by the horizontal physical spacing of seismic sensor units.

Rotational seismic motion is typically defined as ½ of the vector curl of the displacement wavefield, u. Alternatively, in current commercially available rotational sensors, measurements may be made of the time derivative of this rotational displacement which is known as the angular rate, rotational rate, or angular velocity; or, of the second time derivative of this rotational displacement which is known as the angular acceleration. It will be understood by those skilled in the art that in the present the various time derivatives are to be consistently utilized for both the linear and rotational motion measurements.

In the prior art of the Claim Amendments dated July 2012 in the USPTO file wrapper for the U.S. Patent Application 2010/0195439 A1 to Muyzert entitled “Seismic Acquisition System and Technique”, hereinafter referred to as “the '439 Patent Application”, there are present Claims 21-30 for a system, method and apparatus which explicitly incorporate the limitation of “ . . . rotation rate . . . ”. The present invention is a significant departure from this prior art in that it may utilize rotation displacement, rotation rate, or rotation acceleration.

The description of the present invention, without loss of generality, considers that spatial sampling is to be enhanced in the x horizontal coordinate direction. From the mathematical definition of vector curl, we know that in Cartesian coordinates the y component of the rotational seismic motion is given as:

$${θ}_{y} ≡ \frac{1}{2} ( \frac{\partial {u}_{x}}{\partial z} - \frac{\partial {u}_{z}}{\partial x} ) \qquad ( 1 )$$

where θ_{y} is the rotational motion around the y axis, and uₓ, u_{z} are the x and z Cartesian components of the infinitesimal vector displacement field. The operators

$$\frac{\partial }{\partial z} and \frac{\partial }{\partial x}$$

are the partial derivatives in the spatial directions z and x, which will be recognized as spatial gradients.

This equation defines that rotational seismic data is comprised of particular combinations of certain spatial gradients of components of the infinitesimal vector displacement field.

It is known from prior art, for example, PCT Patent Application No. WO 2013/150452 to Edme, et al. entitled “Methods and Systems For Land Seismic Surveying”, hereinafter “the '452 Patent Application”, at p. 13, ll. 8-9 that “ . . . horizontal components of rotational wavefield correspond to the spatial gradients of the vertical wavefield . . . ”.

At the free surface of the earth the air above effectively has zero shear rigidity relative to seismic wavefields. At the bottom of a body of water, the water above effectively has zero shear rigidity relative to seismic wavefields. See for example Patent Application WO 2012/037292 A1 to Brune entitled “Method to Improve Spatial Sampling of Vertical Motion of Seismic Wavefields on the Free Surface of the Earth by Utilizing Horizontal Rotational Motion and Vertical Motion Sensors”, and see also U.S. Patent Application 2012/0113748 A1 to Brune entitled “Method to Improve Spatial Sampling of Vertical Motion of Seismic Wavefields on the Water Bottom by Utilizing Horizontal Rotational Motion and Vertical Motion Sensors”. By utilizing the appropriate boundary conditions, it is seen that Equation (1) can be written as:

$${θ}_{y} = ( - \frac{\partial {u}_{z}}{\partial x} ) \qquad ( 2 )$$

Thus the negative of the measured value of the y component of rotational motion, θ_{y}, is equal to the horizontal spatial gradient, or slope, in the x direction for the linear vertical particle motion, u_{z}, without any other terms involving other components of linear particle motion.

Due to the inclusion of measurements of rotations around one or more horizontal axes, the seismic sensor units 101 may be spaced further apart, as compared to the spacing used with conventional seismic sensor units that measure only linear motions. More specifically, the measured rotations around horizontal axes at the surface of the earth or on a water bottom are proportional to the spatial gradients of the vertical linear motion in horizontal directions orthogonal to the horizontal rotation axes, as described above.

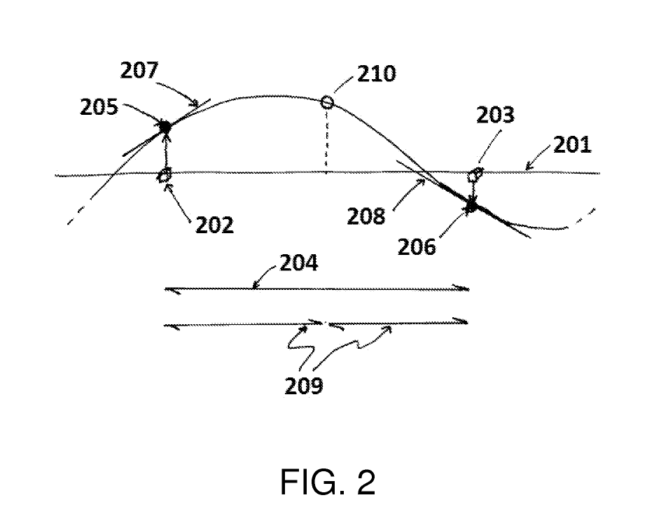

In some embodiments, as shown diagrammatically in FIG. 2, the reconstruction of the seismic wavefield uses the Ordinate and Slope technique. Along the horizontal x axis 201 two locations 202-203 are depicted with a spacing dx 204, at which are seen Ordinate and Slope samples, which are respectively the vertical particle motions, u_{z} 205-206 and the slopes,

$$\frac{\partial {u}_{z}}{\partial x}$$

207-208.

As will be recognized by those skilled in the art, the reconstruction of a wavefield in the x direction by Ordinate and Slope Sampling is done by means of sin c²(x) form of reconstruction functions for the Ordinate, and (x)(sin c2(x)) form of reconstruction functions for the Gradient, with the appropriate scaling for the particular spatial sample interval used. This technique is described, for example, in Bracewell, pp. 230-232.

By utilizing the technique of the present invention, it will be recognized that for data recorded with a spatial sampling of Δx 204, the effective spatial sampling is (Δx/2) 209 as shown in FIG. 2, which is seen to be at twice the spatial sampling rate of the physical recording locations on the free surface of the earth or on the bottom of a body of water. The method of the present invention is seen to be equivalent to having an additional sample of the vertical particle motion, u_{z}, at the intermediate location 210 at a spatial sampling interval of (Δx/2). It will be recognized by those of skill in the art that this effectively doubles the spatial Nyquist frequency for sampling in the x horizontal direction.

In some embodiments this permits the use of the multi-channel sampling theorem for spatial reconstruction of the vertical motion seismic wavefield at points other than the locations of the seismic sensor units. This reconstruction includes spatial frequencies higher than the basic Nyquist spatial frequency limit imposed by the location of seismic sensor units if only vertical linear motion had been measured. In the present invention, basic Nyquist spatial frequency limits are those that would be imposed if only one seismic wavefield linear motion value, and not spatial gradients, were measured.

In general, pursuant to the multi-channel sampling theorem, a function and its derivative may be reconstructed exactly when the function and its derivative are sampled with a spacing of less than one wavelength. The function in the present invention is the linear vertical motion of the seismic wavefield, and the derivative is the horizontal spatial gradient of the linear vertical motion, as measured by rotation around the orthogonal horizontal axis. For embodiments where the vertical motion V(x,t) and its horizontal spatial gradient ∂V(x,t)/∂x are uniformly sampled at locations 2nπ/K_{Nx} along an x horizontal axis at the surface of the earth, or along a water bottom. K_{Nx} is the spatial Nyquist wavenumber for the spacing 2nπ/K_{Nx} of the seismic sensor units if only the vertical linear motion had been sampled, without any gradient or rotational aspect to the measurement. The multi-channel filtering reconstruction utilized in some embodiments of the present invention is given by Equation (92) on page 61 of Marvasti, 2001. With the nomenclature for mathematical variables used in the present invention, this is:

$$V ( x ) = {\sum }_{n = - ∞}^{∞} {\{ V ( \frac{2 n π}{{K}_{Nx}} ) + ( x - \frac{2 n π}{{K}_{Nx}} ) \frac{\partial V}{\partial x} ( \frac{2 n π}{{K}_{Nx}} ) \} [ sin c ( \frac{{K}_{Nx} x}{2 π} - n ) ]}^{2} \qquad ( 3 )$$

Another reference for this algorithm is Robertsson, J., et al., “On the use of multicomponent streamer recordings for reconstruction of pressure wavefields in the crossline direction”, Geophysics, vol. 73, no. 5, pp. A45-A49, September/October, 2008.

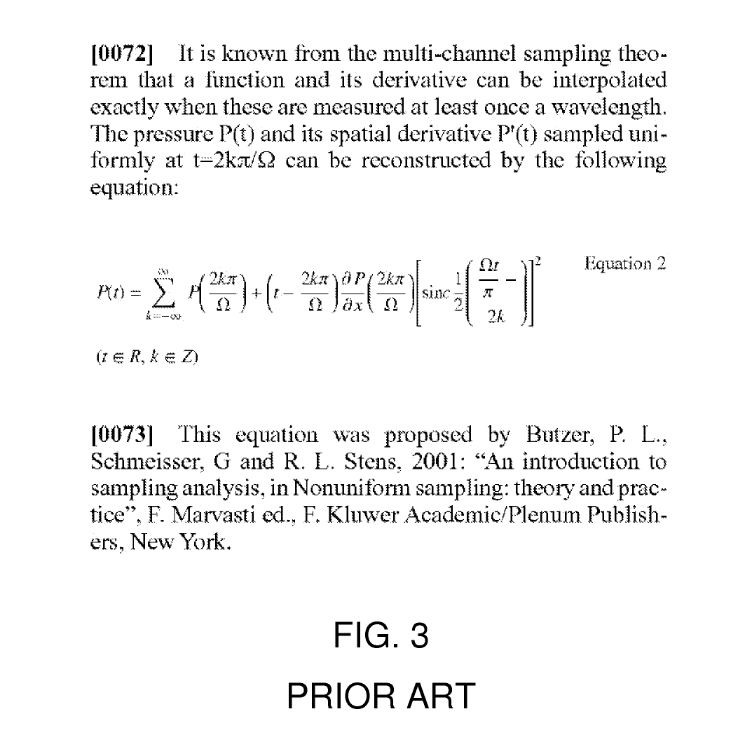

The present invention is a significant departure from prior art. Prior art that is relevant to sample reconstruction techniques utilizing spatial gradients is found in U.S. Patent Application 2010/0302909 A1 to Muyzert entitled “Seismic Sensor Devices”, hereinafter referred to as “the '909 Patent Application”. Aspects of this prior art include the sampling techniques disclosed particularly in Paragraphs [0072] and [0073]. An excerpt from this prior art is depicted in FIG. 3.

An aspect of the equation shown in this prior art is that the term

$${\sum }_{k = - ∞}^{∞} P ( \frac{2 k π}{Ω} )$$

is not multiplied by the term

$${[ sin c \frac{1}{2} ( \frac{Ω t}{π} - 2 k ) ]}^{2} .$$

In a marked departure from the prior art, in the present invention a fundamentally different algorithmic form of an analogous equation is used.

Another aspect of this prior art is that the summation

$${\sum }_{k = - ∞}^{∞}$$

is specifically applicable only to the term

$$P ( \frac{2 k π}{Ω} ) ,$$

and is apparently not applicable to the term involving the spatial derivative. In the present invention, a fundamentally different form of an analogous equation is used.

Relevant prior art includes the '439 Patent application. Aspects of this prior art include the sampling techniques disclosed particularly in paragraphs [0024] and [0025]. Note that this prior art includes the statement: “spatial derivative ∂v(t)/∂x are sampled uniformly at t=2kπ/Ω”. This involves a reconstruction over values of the variable t, but utilizes derivatives with respect to the variable x. The present invention utilizes spatial derivatives over the same variable, x, that is utilized in sample reconstruction.

Other relevant prior art is found in Patent Application WO 2010/090949 A2 to Muyzert entitled “Seismic Acquisition System and Technique”. Aspects of this prior art include sampling techniques as disclosed particularly in paragraphs [0024] and [0025]. There are similar aspects to this prior art as discussed above for the '439 Patent Application. The present invention is a marked departure from the algorithms disclosed in this prior art.

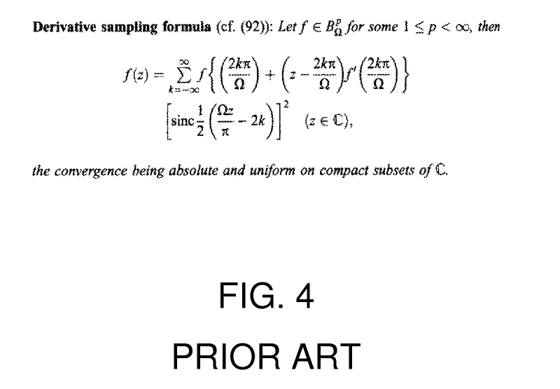

Further prior art that is relevant to sample reconstruction techniques is found in the Butzer, et. al. reference. This prior art is referenced in Paragraph [0073] of the '909 Patent Application. An excerpt from page 86 of the Butzer, et. al. reference is depicted in FIG. 4. Note that this depicts a function f with arguments including the spatial gradient f′. In a marked departure, in the present invention a fundamentally different algorithmic form of an analogous equation is utilized.

In the prior art of the '452 Patent Application there are techniques to utilize the Multi Channel Sampling Theory to enhance the spatial sampling of rotational components by means of spatial differences between nearby sensors. See, for example, p. 13, ll. 3-11; and p. 13 l. 18-p. 14, l. 5. The present invention is a marked departure from this prior art in that the present invention utilizes rotational motion explicitly as a measure of horizontal spatial gradient specifically for the linear vertical motion, rather than using physical differences between nearby rotational sensors to obtain a horizontal spatial gradient of rotational motion.

Those skilled in the art will recognize that the seismic wavefield reconstruction methods of the present invention can be applied in both horizontal directions to improve the spatial sampling of the vertical particle motion in two horizontal dimensions.

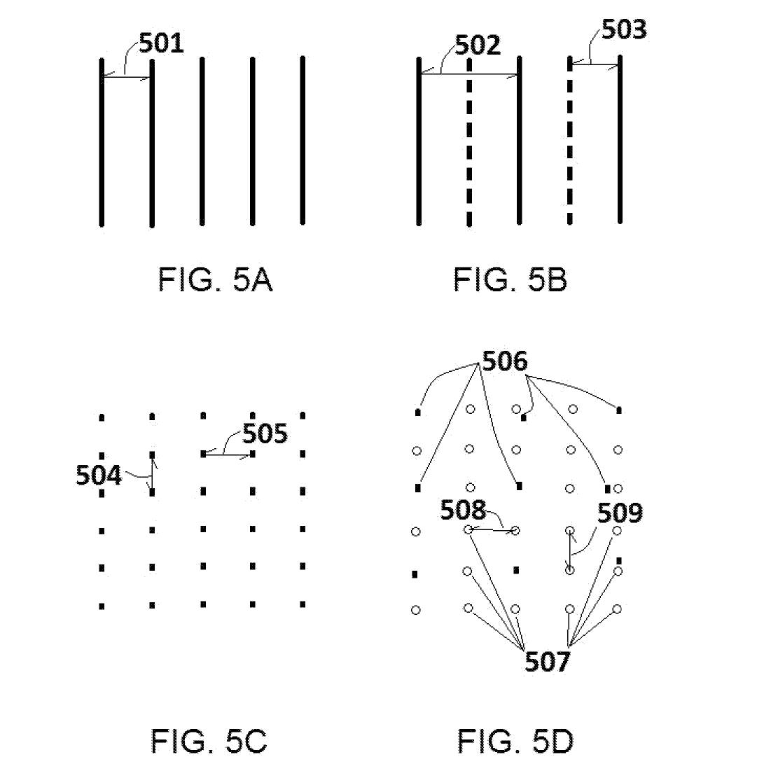

FIGS. 5A-5D depict map views of spatial sampling aspects of the present invention for receiver cable geometries and for autonomous receiver node geometries.

In a particular embodiment, depicted in FIGS. 5A and 5B, consider a 3D seismic survey utilizing parallel receiver lines orthogonal to each other, and with, say, 200 meter crossline spacing 501 between receiver lines. FIG. 5A depicts a typical practice in prior art. Then for each field data record the present invention as depicted in FIG. 5B allows a physical crossline spacing 502 of 400 meters, while still preserving an effective spatial sampling 503 of 200 meters in the crossline direction for the vertical particle motion component of a seismic wavefield.

In other embodiments, depicted in FIG. 5C, there is shown a non-limiting exemplary 3-D seismic survey with inline 504 and crossline 505 spacings between receiver locations on land or on the bottom of a body of water, typically the ocean. In typical practice the inline and crossline spacing may be equal, and may be, say, 660 feet. In other examples the inline and crossline spacings may be unequal and have various values. For each field data record for each seismic source shot, the present invention will yield an effective spatial sampling of half of the physical inline horizontal spacing in both the inline and the crossline direction for the vertical particle motion component of the seismic wavefield.

In some other embodiments, such as depicted in FIG. 5D, the inline and crossline spacing of the grid of the inventive physical seismic sensor units 506 including rotational seismic measurements may be somewhat irregular. As depicted by the solid symbols 506 in FIG. 5D, this spatial irregularity may typically involve variations in inline and crossline spacing on the order of 10 percent, or significantly more or less. In the methods and system of the present invention, the effective spatial sampling of the vertical linear component of motion of the seismic wavefield will have effective crossline spacing 508 and inline spacing 509 that are half of the average spacing of the somewhat irregular physical seismic sensor unit grid 506. The effective grid 507 has these regular spacings 508 and 509.

In accordance with some embodiments of the present invention, the reconstruction of sample locations for the seismic wavefield may utilize numerical algorithmic techniques such as those disclosed in, for example, Marvasti, 2001. Non limiting exemplary techniques may include modifications of Lagrangian interpolation techniques incorporating derivatives as discussed in Marvasti, 2001 on p. 140 ff., p. 217, and elsewhere. Such numerical techniques may be used to process data from the present invention wherein seismic vertical linear motion samples and horizontal spatial gradients from rotational sensors are made available on a somewhat irregular array grid and are then processed so as to yield data on a finer spaced regular spatial array grid.

In accordance with some embodiments of the present invention, ground roll in land seismic, or Scholte wave in Ocean Bottom Seismic, may be attenuated by techniques in multi-dimensional Fourier transform domain without first interpolating. These prior art techniques include f-k filtering, and related technologies that are well known to those skilled in the art.

In accordance with some other embodiments of the present invention, vertical motion seismic data may be reconstructed in the Fourier transform domain. Further, in accordance with some embodiments the Fourier transforms and inverse transforms may be computed by various techniques such as Discrete Fourier Transforms (DFT) that do not necessarily require that the data be initially sampled at uniform spatial intervals. One problem associated with ground roll and Scholte waves is that their short wavelengths require, in general, densely spaced linear particle motion sensors in the inline direction, and also often in the crossline direction. In some embodiments of the present invention a technique is utilized to enhance the spatial sampling in the multi-dimensional Fourier transform domain. An exemplary case for one spatial axis, x, will be described. The vertical linear motion wavefield measured at the surface of the earth or on the water bottom may be described in terms of monochromatic plane wave Fourier components as follows:

V(ω,kₓ)=A(ω,kₓ)exp(+ikₓx−iωt) (4)

Gₓ(ω,kₓ)=(ikₓ)A(ω,kₓ)exp(+ikₓx−iωt) (5)

where:

V(ω,kₓ) is the vertical linear component of motion for a sampled seismic wavefield. It is typically particle velocity or particle acceleration.

Gₓ(ω,kₓ) is the horizontal spatial gradient of the vertical linear component of motion in the z horizontal direction. It is the gradient of particle velocity or particle acceleration analogous to V(ω,kₓ).

A(ω,kₓ) is the Fourier amplitude coefficient, for a time-harmonic, one-spatial-dimension propagating plane wave.

The complex factor exp(+ikₓx−iωt) represents a time-harmonic, one-spatial-dimension propagating plane wave.

Persons having ordinary skill in the art will understand that in the frequency-wavenumber domain, the aliased energy with wavenumbers greater than the Nyquist wavenumber K_{Nx} wraps around and is added to the unaliased frequencies and wavenumbers. When considering only aliased energy that is wrapped around once, the resulting frequency-wavenumber spectra may be described as:

V(ω,kₓ)=Aᵤₐₓ(ω,kₓ)+Aₐₗₓ(ω, 2K_{Nx}−kₓ) (6)

Gₓ(ω,kₓ)=i(kₓ)Aᵤₐₓ(ω,kₓ)+i(2K_{Nx}−kₓ)Aₐₗₓ(ω, 2K_{Nx}−kₓ) (7)

where:

Aᵤₐₓ(ω,kₓ) represents the unaliased sampled seismic wavefield spectrum. This term is considered as non-zero only for kₓ between 0 and kₓ.

Aₐₗₓ(ω, 2K_{Nx}−kₓ) represents the aliased sampled seismic wavefield spectrum, with spectral wraparound. This term is considered as non-zero only for (2K_{Nx}−kₓ) between K_{Nx} and 2K_{Nx}

The factor i(2K_{Nx}−kₓ) represents the spectral amplitude and phase effect of the aliased spatial gradient of the sampled seismic wavefield.

The amplitudes of the unaliased part of the f-k spectrum may be recovered as follows. Re-arranging Eq. (6):

Aᵤₐₓ(ω,kₓ)=V(ω,kₓ)−Aₐₗₓ(ω, 2K_{Nx}−kₓ) (8)

Then, using Eq. (7) in Eq. (8):

$${A}_{uax} ( ω , {k}_{x} ) = V ( ω , {k}_{x} ) - \frac{1}{i ( 2 {K}_{Nx} - {k}_{x} )} [ {G}_{x} ( ω , {k}_{x} ) - i ( {k}_{x} ) {A}_{uax} ( ω , {k}_{x} ) ] \qquad ( 9 )$$

This can be rearranged:

$${A}_{uax} ( ω , {k}_{x} ) = ( \frac{2 {K}_{Nx} - {k}_{x}}{2 {K}_{Nx} - 2 {K}_{x}} ) V ( ω , {k}_{x} ) - \frac{1}{i ( 2 {k}_{Nx} - 2 {k}_{x} )} {G}_{x} ( ω , {k}_{x} ) \qquad ( 10 )$$

In a similar manner, the amplitudes of the part of the f-k spectrum that would have been aliased if the gradient measurements were not also available may be recovered as follows. Re-arranging Eq. (3):

Aₐₗₓ(ω, 2K_{Nx}−kₓ)=V(ω,kₓ)−Aᵤₐₓ(ω,kₓ) (11)

Using Eq. (7) in (11):

$${A}_{alx} ( ω , 2 {K}_{Nx} - {k}_{x} ) = V ( ω , {k}_{x} ) - \frac{1}{{ik}_{x}} [ {G}_{x} ( ω , {k}_{x} ) - i ( 2 {K}_{Nx} - {k}_{x} ) {A}_{alx} ( ω , 2 {K}_{Nx} - {k}_{x} ) ] \qquad ( 12 )$$

This can be rearranged:

$${A}_{alx} ( ω , 2 {K}_{Nx} - {k}_{x} ) = - ( \frac{{k}_{x}}{2 {K}_{Nx} - 2 {k}_{x}} ) V ( ω , {k}_{x} ) + \frac{1}{i ( 2 {K}_{Nx} - 2 {k}_{x} )} {G}_{x} ( ω , {k}_{x} ) \qquad ( 13 )$$

The inventive Fourier domain techniques disclosed in Equations (4)-(13) and the associated discussion above may be used for seismic wavefield sample reconstruction, using horizontal spatial gradients obtained from horizontal rotational measurements. These inventive techniques may further be used for embodiments having irregular spatial sampling. These inventive techniques may further be used for embodiments to perform enhanced f-k filtering beyond the basic Nyquist wavenumber limit to suppress source generated seismic noise such as Rayleigh waves and Scholte waves.

Persons having ordinary skill in the art will readily understand that the inventive Fourier domain techniques disclosed in Equations (4)-(13) and the associated discussion above represent a significant departure from the particular prior art disclosed in the '439 Patent Application. For example, those of ordinary skill will recognize that Nyquist aliasing wavenumber wraparound expression in the case of x direction wavenumbers is to be expressed as:

2K_{Nx}−kₓ

However, we find in Eqs. (5) and (6) of the '439 Patent Application that the wraparound expression is incorporated in the form:

kₓ+K_{Nx}

Those of ordinary skill will of necessity find that this is fundamentally different from the present invention, and by conventional technical standards would be considered to be conceptually incorrect and to lack utility for use in seismic surveys.

Those Skilled In The Art will appreciate that the disclosure of the present invention represents significant departures from the prior art. Further, only a limited number of embodiments of the present invention have been described is this disclosure. However, those Skilled In The Art will appreciate that there are numerous modifications and variations that are possible. The appended claims are intended to cover all modifications and variations that fall within the true spirit and scope of this present invention.

A limited number of embodiments have been described herein. Those skilled in the art will recognize other embodiments within the scope of the claims of the present invention.

It is noted that many of the structures, materials, and acts recited herein can be recited as means for performing a function or step for performing a function. Therefore, it should be understood that such language is entitled to cover all such structures, materials, or acts disclosed within this specification and their equivalents, including any matter incorporated by reference.

It is thought that the apparatuses and methods of embodiments described herein will be understood from this specification. While the above description is a complete description of specific embodiments, the above description should not be taken as limiting the scope of the patent as defined by the claims.

Other aspects, advantages, and modifications will be apparent to those of ordinary skill in the art to which the claims pertain. The elements and use of the above-described embodiments can be rearranged and combined in manners other than specifically described above, with any and all permutations within the scope of the disclosure.

Although the above description includes many specific examples, they should not be construed as limiting the scope of the method, but rather as merely providing illustrations of some of the many possible embodiments of this method. The scope of the method should be determined by the appended claims and their legal equivalents, and not by the examples given.

What is claimed is:

1. A method for reconstructing seismic wavefield samples representative of wavenumbers beyond the basic Nyquist spatial sampling wavenumber comprising:
deploying a plurality of seismic sensor units in a sensor array incorporating both linear and rotational sensing elements designed for seismic sensitivities and frequencies and
reconstructing seismic wavefield samples representative of wavenumbers beyond the basic Nyquist spatial sampling wavenumber limit that would be imposed by the seismic sensor unit spacing utilized if only vertical linear components of motion were recorded.

2. The method of claim 1 wherein reconstructing seismic wavefield samples representative of wavenumbers beyond the basic Nyquist spatial sampling wavenumber further comprises:
measuring Fourier components of the wavefield and horizontal spatial gradient of the wavefield;
representing the wavefield and horizontal spatial gradient of the wavefield by a pair of linear equations in terms of an aliased and an unaliased portion of the wavefield and
representing the spatially aliased and spatially unaliased portions of the wavefield in terms of the wavefield and horizontal spatial gradient as a mathematical solution of said pair of equations.

3. The method of claim 1 wherein the sensor array is wholly uniformly spaced.

4. The method of claim 1 wherein the sensor array is partially uniformly spaced.

5. The method of claim 1 wherein the sensor array is non-uniformly spaced.

6. The method of claim 1 wherein the sensor array is positioned on land.

7. The method of claim 1 wherein the sensor array is positioned on the bottom of a body of water.

8. A method for enhancing attenuation of seismic noise comprising:
performing f-k filtering or equivalents on a data set in temporal and spatial Fourier transform domain, wherein spatial wavenumbers beyond the basic Nyquist spatial sampling wavenumber limit that would be imposed by the seismic sensor unit spacing are created by:
recording the wavefield and its horizontal spatial gradient at sensor locations;
calculating the spatial Fourier components of the wavefield and its horizontal spatial gradient;
equating the wavefield and its horizontal spatial gradient, each in one of a pair of equations, each in terms of unknown aliased and unaliased portions of the wavefield; and
calculating the spatially aliased portion and the spatially unaliased portions of the spatial Fourier component representation of the wavefield.

9. The method of claim 8 wherein the seismic noise comprises ground roll.

10. The method of claim 8 wherein the seismic noise comprises Rayleigh waves,

11. The method of claim 8 wherein the seismic noise comprises Scholte waves,

12. The method of claim 8 wherein the seismic noise comprises other source generated seismic noise.

13. The method of claim 8 wherein the seismic noise is detected on the surface of the land.

14. The method of claim 8 wherein the seismic noise is detected on the bottom of a body of water.

15. A system for reconstructing seismic wavefield samples representative of wavenumbers beyond the basic Nyquist spatial sampling wavenumber comprising:
a plurality of seismic sensor units incorporating both linear and rotational sensing elements that are designed for seismic sensitivities and frequencies, deployed in a partly or wholly uniform and/or non-uniformly spaced array on land or on the bottom of a body of water, and
at least one computer to reconstruct seismic wavefield samples representative of wavenumbers beyond the basic Nyquist spatial sampling wavenumber limit that would be imposed by the seismic sensor unit spacing utilized if only vertical linear components of motion were recorded.

16. The system of claim 15 wherein the linear and rotational sensing elements sense linear particle acceleration and rotational acceleration, respectively.

17. The system of claim 15 wherein the linear and rotational sensing elements sense linear particle velocity and angular velocity, respectively.

18. The system of claim 15 wherein reconstructing seismic wavefield samples representative of wavenumbers beyond the basic Nyquist spatial sampling wavenumber further comprises:
measuring Fourier components of the wavefield and horizontal spatial gradient of the wavefield;
representing the wavefield and horizontal spatial gradient of the wavefield by a pair of linear equations in terms of an aliased and an unaliased portion of the wavefield and
representing the spatially aliased and spatially unaliased portions of the wavefield in terms of the wavefield and horizontal spatial gradient as a mathematical solution of said pair of equations.
